(19) United States
(12) Patent Application Publication
(10) Pub. No.: US 2022/0280911 A1
(43) Pub. Date: Sep. 8, 2022

(54) INCREASING HYDROTHERMAL STABILITY OF AN ADSORBENT COMPRISING A SMALL PORE ZEOLITE IN A SWING ADSORPTION PROCESS

(71) Applicant: ExxonMobil Research and Engineering Company, Annandale, NJ (US)

(72) Inventors: Yu Wang, Lebanon, NJ (US); Quanchang Li, Dayton, NJ (US); Stephen M. Cundy, Lebanon, NJ (US); Harry W. Deckman, Clinton, NJ (US)

(21) Appl. No.: 17/634,960

(22) PCT Filed: Jul. 1, 2020
(86) PCT No.: PCT/US20/40487

§ 371 Date: Feb. 11, 2022

Related U.S. Application Data
(60) Provisional application No. 62/886,445, filed on Aug. 14, 2019.

(51) Int. Cl. B01J 20/18; B01J 20/32; B01D 53/047

(52) U.S. Cl. CPC B01J 20/183; B01J 20/3259; B01D 53/0473; B01D 2253/108; B01D 2253/25; B01D 2253/308; B01D 2257/504; B01J 20/3491

(57) ABSTRACT

A method of increasing hydrothermal stability of an adsorbent comprising a small pore cationic zeolite in a swing adsorption process is disclosed. The method comprises the steps of coating the zeolite with a silylation agent to result in a silylated zeolite; and performing the swing adsorption process. The swing adsorption process comprises contacting the silylated zeolite with feed stream comprising water. The swing adsorption process may comprise removing CO₂ from a feed stream comprising CO₂ and water.

### FIELD

The present invention relates to a method of increasing hydrothermal stability of an adsorbent comprising a small pore cationic zeolite in a swing adsorption process. The swing adsorption process may involve removal of CO₂ from a feed stream.

### BACKGROUND

Adsorptive gas and liquid separation techniques, which are common in various industries, use solid adsorbents comprising materials such as activated charcoal or a porous solid oxide such as alumina, silica-alumina, silica, or a zeolite. Zeolites are especially suitable for selective adsorption and separation of an acid gas and/or water from a feed stream. For example, certain zeolites have high acid gas removal capacity and water removal capacity. They can be used in the swing adsorption process with one vessel in adsorption mode to remove the acid gas/water and in another vessel in regeneration mode to regenerate the adsorbed acid gas/water.

During the swing cycles, the capacity of the adsorbents decreases over time as a function of the number of regeneration cycles. Hence, the adsorbents have to be replaced, which could be disruptive and expensive. Therefore, there is a need to increase the lifetime of the absorbents by increasing the hydrothermal stability of the adsorbents, especially of adsorbents comprising small pore zeolites, in swing adsorption processes, without a substantial loss in their adsorption kinetics.

It has been demonstrated that the stability of zeolite beta, which is not a small pore zeolite, in hot liquid water can be improved by reaction with trimethylchlorosilane. By selectively removing the missing silicon-oxygen bonds in zeolite beta having a 12 membered ring structure, the microporosity, sorption capacity, and long-range order of the stabilized material were fully retained even after prolonged exposure to hot liquid water. See Prodinger, S. et al., “Improving Stability of Zeolites in Aqueous Phase via Selective Removal of Structural Defects,” J. Am. Chem. Soc., 138, 4408-4415 (2016).

It has also been demonstrated that the hydrothermal stability and hydrophobicity of the mesoporous molecular sieve MCM-48 membrane can be enhanced by silylation with trimethylsilane and triethylsilane. See Park, D-H et al., “Enhancement of Hydrothermal Stability and Hydrophobicity of a Silica MCM-48 Membrane by Silylation,” Ind Eng. Chem. Res., 40, 6105-6110 (2001). Zeolite MCM-48 is not a small pore zeolite. This water adsorption study showed that the average pore size of zeolite MCM-48 decreased by about 0.5 nm upon silylation. This study also showed that the nature of the pore surface of MCM-48 significantly changed to hydrophobic by silylation. This is expected for meso or large pore zeolites, since silylation converts hydrophilic pore surface of such zeolites to hydrophobic.

Silylation of small pore zeolites has been demonstrated. See, e.g., U.S. Patent Application Publication No. 2010/0068474 A1, Japanese Patent No. JP 4887493 B2, Chinese Patent No. CN 102992341 B, Korean Patent No. KR 101743760 B1, and European Patent No. EP 0088158 B1. These references do not evaluate hydrothermal stability of the silylated zeolites in swing adsorption processes.

None of these references relate to increasing hydrothermal stability of an adsorbent comprising a small pore zeolite in a swing adsorption process. Small pore zeolites and swing adsorption processes pose unique challenges, and the solutions that work for large pore zeolites or in other processes, are not transferable to the specific swing adsorption processes using small pore zeolites that are disclosed herein.

### SUMMARY

The disclosure herein refers to a method of increasing hydrothermal stability of an adsorbent comprising a small pore zeolite in a swing adsorption process.

In one aspect, the present invention is a method comprising the steps of: coating the zeolite with a silylation agent to result in a silylated zeolite; and performing the swing adsorption process. The swing adsorption process comprises contacting the silylated zeolite with feed stream comprising water. The zeolite is a small pore cationic zeolite.

In another aspect, the present invention is a method of increasing hydrothermal stability of an adsorbent comprising a zeolite in a swing adsorption process for removal of CO₂ from a feed stream, the process comprising the steps of: coating the zeolite with a silylation agent to result in a silylated zeolite; and performing the swing adsorption process for removal of CO₂ from the feed stream. The feed stream comprises CO₂ and water, and the swing adsorption process comprises contacting the silylated zeolite with the feed stream. The zeolite is a small pore cationic zeolite.

In some embodiments, the small pore zeolite has an 8 membered ring structure.

In some embodiments, the small pore zeolite has a maximum effective pore size of less than about 5 Å.

In some embodiments, the zeolite is coated with a silylation agent before formulating the adsorbent.

In some embodiments, the zeolite is coated with a silylation agent after formulating the adsorbent.

In some embodiments, the swing adsorption process is pressure swing adsorption (PSA) process, temperature swing adsorption (TSA) process, pressure temperature swing adsorption (PTSA) process, vacuum swing adsorption (VSA) process, vacuum temperature swing adsorption (VTSA) process, partial pressure purge displacement (PPSA) process, partial pressure temperature swing adsorption (PPTSA) process, displacement desorption swing adsorption (DDSA) process, or combination thereof.

In some embodiments, the swing adsorption process removes water from the feed stream.

In some embodiments, the feed stream further comprises an acid gas. In some embodiments, the acid gas is H₂S or CO₂.

In some embodiments, the silylation agent has the general formula:

SiR¹R²R³R⁴,

wherein at least one of the radicals R¹, R², R³, or R⁴ contains a hydrolysable group, and the remaining radicals R¹, R², R³, or R⁴ are, independently of one another, an alkyl, alkenyl, alkynyl, heteroalkyl, cycloalkyl, heteroaryl, alkylcycloalkyl, hetero(alkylcycloalkyl), heterocycloalkyl, aryl, arylalkyl or hetero(arylalkyl) radical.

### BRIEF DESCRIPTION OF DRAWINGS

FIG. 1 illustrates a potential silylation reaction that occurs on the surface of the zeolite.

FIG. 2 illustrates the thermogravimetric analysis (TGA) set-up used to perform the hydrothermal stability evaluations in a laboratory.

FIG. 3 illustrates a plot comparing the degradation (resultant CO₂ capacity loss) of zeolite 5A after temperature swing cycles with and without acid streams.

FIG. 4 illustrates a plot comparing the degradation (resultant CO₂ capacity loss) of zeolite 5A with different water levels after temperature swing from 35° C. to 400° C.

FIG. 5 illustrates a plot comparing the degradation (resultant CO₂ capacity loss) of zeolite 5A with different water levels after temperature swing from 35° C. to 250° C.

FIG. 6 illustrates silylated zeolite 5A (“H-5A” on left) and the original, fresh zeolite 5A (“5A” on right).

FIG. 7 illustrates a plot comparing the TGA results for silylated zeolite 5A with that of the original, fresh zeolite 5A that has not undergone silylation.

FIG. 8 illustrates a plot comparing the diffusivity of silylated zeolite 5A with that of the original, fresh zeolite 5A that has not undergone silylation.

FIG. 9 illustrates a plot comparing the CO₂ isotherm at 30° C. for silylated zeolite 5A with that of the original, fresh zeolite 5A that has not undergone silylation.

FIG. 10 illustrates a plot comparing the CO₂ capacity loss of silylated zeolite 5A (silylation agent: HDMS) with that of the original, fresh zeolite 5A that has not undergone silylation.

FIG. 11 illustrates a plot comparing the CO₂ capacity loss of silylated zeolite 5A (silylation agent: Trimethylsilyl chloride) with that of the original, fresh zeolite 5A that has not undergone silylation.

FIG. 12 illustrates a plot comparing the water uptake capacity at 3 torr and 35° C. of silylated zeolite 5A with that of the original, fresh zeolite 5A that has not undergone silylation.

### DETAILED DESCRIPTION

The disclosure herein refers to a method of increasing hydrothermal stability of an adsorbent comprising a small pore zeolite in a swing adsorption process.

The hydrothermal stability of an adsorbent comprising any of the naturally occurring or synthetic crystalline small pore zeolites may be increased by the method of the present invention. Zeolites and their isotypes are described in the “Atlas of Zeolite Structure Types,” eds. W. H. Meier, D. H. Olson, and Ch. Baerlocher, Elsevier, Fourth Edition, 1996, which is incorporated by reference. A person of ordinary skill in the art knows how to make the various zeolites having the framework structures disclosed herein. For example, see the references provided in the International Zeolite Association's database of zeolite structures found at www.iza-structure.org/databases.

Small pore zeolites are described in literature. See, e.g., Dussclier, M. et al., “Small-Pore Zeolites: Synthesis and Catalysis”, Chem. Rev., 118, 11, 5265-5329 (2018), which is incorporated by reference. In one embodiment, the small pore zeolite has a maximum effective pore size of less than about 5 Å. Alternatively, the small pore zeolite has a maximum effective pore size of less than about 4.5 Å. Alternatively, the small pore zeolite has a maximum effective pore size of less than about 4 Å.

In one embodiment, the small pore zeolite has an 8 membered ring structure. Non-limiting examples of the structure type of the small pore 8 member ring zeolite include, e.g., ABW, AEI, AFX, ANA, ATT, BCT, BIK, BRE, CAS, CDO, CHA, DDR, EAB, EDI, EEI, EPI, ERI, ESV, GIS, GOO, IHW, ITE, JBW, KFI, LEV, LTA, LTJ, LTN, MER, MON, MTF, MWF, NSI, PAU, PHI, RHO, RTH, SAS, SFW, THO, TSC, UFI, YUG, ETL, IFY, ITW, RTE, RWR, or combinations thereof [using the nomenclature of the International Union of Pure and Applied Chemistry (IUPAC) Commission of Zeolite Nomenclature].

In some embodiments, the small pore zeolite comprises a structure type LTA, ZK-4, CHA, RHO, or combinations thereof. In one example, the small pore zeolite comprises zeolite Type A structure, for example, zeolite 5A.

In some embodiments, the small pore zeolites may be produced with differing silica to alumina molar ratios ranging from 1:1 upwards. They have been, in fact, produced from reaction mixtures from which alumina is intentionally excluded, so as to produce materials having extremely high silica to alumina ratios which, in theory at least, may extend up to infinity, prior to treatment according to the invention. In one embodiment, the small pore zeolite has a silica to alumina ratio within the range of about 1:1 to 2000:1.

The method of the present invention preferably does not employ a large pore zeolite. In some embodiments, the method of the present invention preferably does not employ a large pore zeolite generally having its largest pore with a maximum effective pore size greater than about 6 Å. In some embodiments, the method of the present invention preferably does not employ a large pore zeolite having a 12 membered or larger ring structure.

“Cationic zeolite” as used herein refers to a zeolite that is at least partially exchanged with one or more monovalent and/or multivalent cations. The monovalent cation(s) is/are generally alkaline cations. The multivalent cation(s) is/are generally divalent or trivalent cations and are generally alkaline-earth cations or lanthanides. Non-limiting examples of suitable cations include, e.g., K⁺, Na⁺, Mg²⁺, Ca²⁺, or combinations thereof.

Silylation is a well-known tool in both analytical and synthetic chemistry. It has been used since the late fifties in gas chromatography and mass spectrometry, for the derivatization of a wide variety of products and functional groups. As noted above, silylation has been used to enhance stability of zeolite beta having a 12 membered ring structure and mesopore Silica MCM-48 membrane, both of which are not small pore zeolites. See Prodinger, S. et al., “Improving Stability of Zeolites in Aqueous Phase via Selective Removal of Structural Defects,” J. Am. Chem. Soc., 138, 4408-4415 (2016); Park, D-H et al., “Enhancement of Hydrothermal Stability and Hydrophobicity of a Silica MCM-48 Membrane by Silylation,” Ind. Eng. Chem. Res., 40, 6105-6110 (2001).

The silylation agent used in the present invention is well-known to those having ordinary skill in the art. For example, U.S. Patent Application Publication No. 2010/0068474 A1, which is incorporated by reference herein, discloses the use of silylation agent to functionalize molecular sieves, which also include zeolites, to have good dispersity in nonpolar solvents.

In some embodiments, the silylation agent has the general formula:

SiR¹R²R³R⁴,

wherein at least one of the radicals R¹, R², R³, or R⁴ contains a hydrolysable group, and the remaining radicals R¹, R², R³, or R⁴ are, independently of one another, an alkyl, alkenyl, alkynyl, heteroalkyl, cycloalkyl, heteroaryl, alkylcycloalkyl, hetero(alkylcycloalkyl), heterocycloalkyl, aryl, arylalkyl or hetero(arylalkyl) radical.

As disclosed in U.S. Patent Application Publication No. 2010/0068474 A1, the term “hydrolysable group” as used herein refers to a group which is split off on reaction with water, whereupon the terminal part of the group (that is to say that part which is remote from the central silicon atom) is separated off from the residual molecule comprising the central silicon atom and there is formed on the residual molecule comprising the central silicon atom a hydroxide function, that is to say the group —OH. In other words, a hydrolysable group as understood by the invention is preferably a potential leaving group which is split off, or released, for example on reaction with water. Hydrolysable groups of such a kind are also split off by other molecules—apart from water—which have terminal hydroxy functions (that is to say the group —OH), for example by alcohols, protonic acids, e.g. carboxylic acids, sulfur oxygen acids or phosphorus oxygen acids, or also by free hydroxy groups on the surface of oxidic solids.

In some embodiments, the hydrolysable group is hydrogen, F, Cl, Br, I, NH, HNSiR⁵R⁶R⁷, or OR⁸ radical, wherein R⁵, R⁶, and R⁷ radicals are, independently of one another, an alkyl or fluorinated alkyl radical; and R⁸ is an alkyl radical.

Non-limiting examples of the silylation agent include, e.g., acetoxysilanes, acetylsilanes, acryloxysilanes, adamantylsilanes, allylsilanes, alkylsilanes, allyloxysilanes, alkenylsilanes, alkoxysilanes, alkynylsilanes, aminosilanes, azidosulfonylsilanes, benzoyloxysilanes, benzylsilanes, bromoalkylsilanes, bromoalkenylsilanes, bromovinylsilanes, alkoxycarbonylsilanes, chloroalkylsilanes, chloroalkenylsilanes, chlorovinylsilanes, cycloalkylsilanes, cycloalkenylsilanes, diphenylsilanes, ditolylsilanes, epoxysilanes, fluorinated silanes, for example fluorinated alkylalkoxysilanes, e.g., (3-heptafluoroisopropoxy)propyl-trimethoxysilanes, (CF₃)₂CF—O—C₃H₆Si(OCH₃)₃, or fluorinated alkylsilanes, e.g., (heptadecafluoro-1,1,2,2-tetrahydrodecyl)triethoxysilanes, methacryloxysilanes, naphthylsilanes, pentafluorophenylsilanes, phenylsilanes, propargylsilanes, propargyloxysilanes, silyl cyanides, silyl phosphates, or vinyl silanes.

In one embodiment, the silylation agent is hexamethyldisilazane (HMDS). Alternatively, the silylation agent is a trimethylsilane. Non-limiting examples of trimethylsilane include, e.g., trimethylsilyl chloride, (chloromethyl)trimethylsilane, (iodomethyl)trimethylsilane, (3-chloropropyl)trimethylsilane, or (bromomethyl)trimethyl si lane.

The small pore the zeolite is coated with a silylation agent to result in a silylated zeolite. In some embodiments, the zeolite is coated with a silylation agent before formulating the adsorbent, which is typically in the form of pellets. In some embodiments, the zeolite is coated with a silylation agent after formulating the adsorbent, which is typically in the form of pellets.

As used herein, the term “adsorption” includes physisorption, chemisorption, and condensation onto a solid support, adsorption onto a solid supported liquid, chemisorption onto a solid supported liquid and combinations thereof.

Swing adsorption processes are all well-known to those having ordinary skill in the art. For example, see U.S. Patent Publication No. 2017/0136405, which is incorporated by reference herein. The swing adsorption processes can be applied to remove a variety of target gases from a wide variety of gas mixtures.

Non-limiting examples of the swing adsorption process of the present invention include, e.g., temperature swing adsorption (TSA), pressure swing adsorption (PSA), pressure temperature swing adsorption (PTSA) process, vacuum swing adsorption (VSA) process, vacuum temperature swing adsorption (VTSA) process, partial pressure purge displacement (PPSA) process, partial pressure temperature swing adsorption (PPTSA) process, displacement desorption swing adsorption (DDSA) process, or combination thereof. These swing adsorption processes can be conducted with rapid cycles, in which case they are referred to as rapid cycle thermal swing adsorption (RCTSA), rapid cycle pressure swing adsorption (RCPSA), and rapid cycle partial pressure swing or displacement purge adsorption (RCPPSA) technologies. “Swing adsorption process” as used herein shall be taken to include all of these processes, including combinations of these processes.

All swing adsorption processes have an adsorption step in which a feed stream comprising a mixture (typically in the gas phase) is flowed over an adsorbent that preferentially adsorbs a more readily adsorbed component relative to a less readily adsorbed component. A component may be more readily adsorbed because of kinetic or equilibrium properties of the adsorbent material. The resultant product stream has lesser amount of the adsorbed material than the feed stream.

In some embodiments, the swing adsorption process is a PSA process. PSA processes rely on the fact that gases under pressure tend to be adsorbed within the pore structure of the adsorbent materials. Typically, the higher the pressure, the greater the amount of targeted gas component that will be adsorbed. When the pressure is reduced, the adsorbed targeted component is typically released, or desorbed. PSA processes can operate across varying pressures. For example, a PSA process that operates at pressures below atmospheric pressure is a vacuum swing adsorption (VSA) process.

In some embodiments, the swing adsorption process is a TSA process. TSA processes also rely on the fact that gases under pressure tend to be adsorbed within the pore structure of the adsorbent materials. When the temperature of the adsorbent is increased, the adsorbed gas is typically released, or desorbed. By cyclically swinging the temperature of adsorbents, TSA processes can be used to separate gases in a mixture when used with an adsorbent selective for one or more of the components in a gas mixture. Partial pressure purge displacement (PPSA) swing adsorption processes regenerate the adsorbent with a purge.

In some embodiments, the swing adsorption process is a rapid cycle (RC) swing adsorption process. RC processes complete the adsorption step of a swing adsorption process in a short amount of time. For kinetically selective adsorbents, it can be preferable to use a rapid cycle swing adsorption process. If the cycle time becomes too long, the kinetic selectivity can be lost.

The swing adsorption process of the present invention is used with feed stream comprising water. The process comprises contacting the adsorbent with the silylated zeolite with the feed stream comprising water.

In some embodiments, the swing adsorption process removes water from the feed stream. In one embodiment, the swing adsorption process results in a product stream with less than about 10 ppm of water. Alternatively, the swing adsorption process results in a product stream with less than about 1 ppm of water. Alternatively, the swing adsorption process results in a product stream with less than about 0.1 ppm of water.

In some embodiments, the swing adsorption process is used with feed stream comprising an acid gas and water. In one embodiment, the acid gas is H₂S or CO₂. In one example, the acid gas is CO₂.

In another aspect, the swing adsorption process removes CO₂ from a feed stream comprising CO₂ and water. In one embodiment, the swing adsorption process removes CO₂ from a feed stream comprising CO₂ and low levels of water. In some embodiments, the swing adsorption process removes CO₂ from a feed stream comprising CO₂ and less than about 1000 ppm of water. Alternatively, the swing adsorption process removes CO₂ from a feed stream comprising CO₂ and less than about 100 ppm of water. Alternatively, the swing adsorption process removes CO₂ from a feed stream comprising CO₂ and less than about 10 ppm of water.

In one embodiment, the swing adsorption process results in a product stream with less than about 100 ppm of CO₂. Alternatively, the swing adsorption process results in a product stream with less than about 50 ppm of CO₂.

As noted above, during the swing cycles of a swing adsorption process, the capacity of the adsorbents decreases over time as a function of the number of regeneration cycles. Therefore, end-of-run (EOR) capacity must be taken into account when considering the required amount of an adsorbent. However, it was not well-known that adsorbents with a small pore zeolite degrade much more severely and much faster when exposed to wet feed streams, especially wet feed streams comprising acidic gases, than compared to dry feed streams or feed streams without water, including dry feed streams comprising acidic gases. The degradation of the small pore zeolite was found to be dependent on the water level in the wet feed stream.

The method of the present invention increases the lifetime of an adsorbent comprising a small pore zeolite used in a swing adsorption process involving a wet feed stream. This is achieved by improving hydrothermal stability of the adsorbent. Increasing the lifetime of an adsorbent results in cost savings and alleviates the need to stop the adsorptive separation process in order to replace the degraded adsorbent. “Hydrothermal stability” of an adsorbent as used herein refers to the ability of the adsorbent to withstand many sustained cycle conditions, including removing water at elevated temperature during regeneration step of a swing adsorption process and adsorbing water at high water partial pressure at room temperature during adsorption step of the swing adsorption process. “Improved hydrothermal stability” of an adsorbent as used herein may be observed when an adsorbent demonstrates less than about 20% decrease in equilibrium adsorptive capacity compared to that of the original, fresh adsorbent that has not undergone the silylation, under same cycle conditions of a swing adsorption process.

The inventors of the present application have unexpectedly found that the hydrothermal stability of an adsorbent comprising a small pore cationic zeolite can be increased by the silylation process described herein. The present invention not only advantageously slows down the degradation of the adsorbent in the swing adsorption process comprising a feed stream comprising water or an acid gas and water, but it does so by substantially maintaining properties such as the equilibrium adsorptive properties with respect to small molecules (such as, water or acidic gas molecules), especially the mass transfer rate to reach equilibrium adsorptive capacity for rapid cycle swing adsorption process. Such properties of the silylated small pore cationic zeolites were surprisingly substantially equivalent to that of the original, fresh zeolites that have not undergone silylation of the present invention. For example, in one embodiment, there was no observable slowing down in the mass transfer rate to reach equilibrium adsorptive capacity of the silylated zeolite compared to that of the original, fresh zeolite that has not undergone silylation. The process involves the steps of coating the small pore cationic zeolite with a silylation agent to result in a silylated zeolite; and performing the swing adsorption process, wherein the swing adsorption process comprises contacting the silylated zeolite with feed stream comprising water, or feed stream comprising an acid gas (such as CO₂ or H₂S) and water.

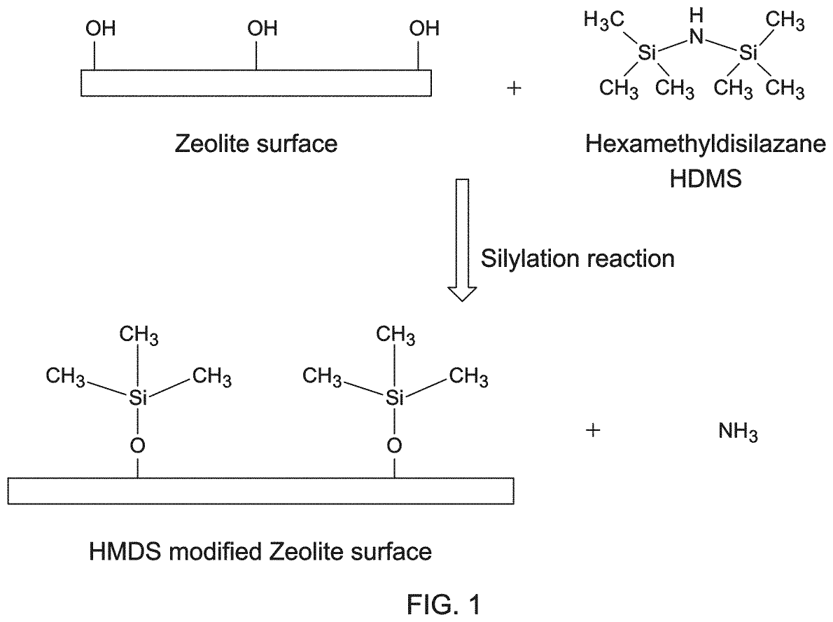

Without being bound by theory, it is hypothesized that silylation of the small pore cationic zeolite causes a substitution of silanol groups on the surface of the zeolite with silyl groups (see, e.g., FIG. 1), which results in increasing hydrophobicity and reducing acidic attacks on the zeolite structure.

In one embodiment, the swing adsorption process using an adsorbent comprising a silylated zeolite in accordance with the present invention is operated for about one year before having to replace the adsorbent due to degradation of its adsorptive capacity. Alternatively, the swing adsorption process is operated for about 2 years before having to replace the adsorbent due to degradation of its adsorptive capacity. Alternatively, the swing adsorption process is operated for about 3 years before having to replace the adsorbent due to degradation of its adsorptive capacity.

In a laboratory, accelerated hydrothermal stability testing of an adsorbent comprising a small pore cationic zeolite may be evaluated using a thermogravimetric analysis (TGA) instrument.

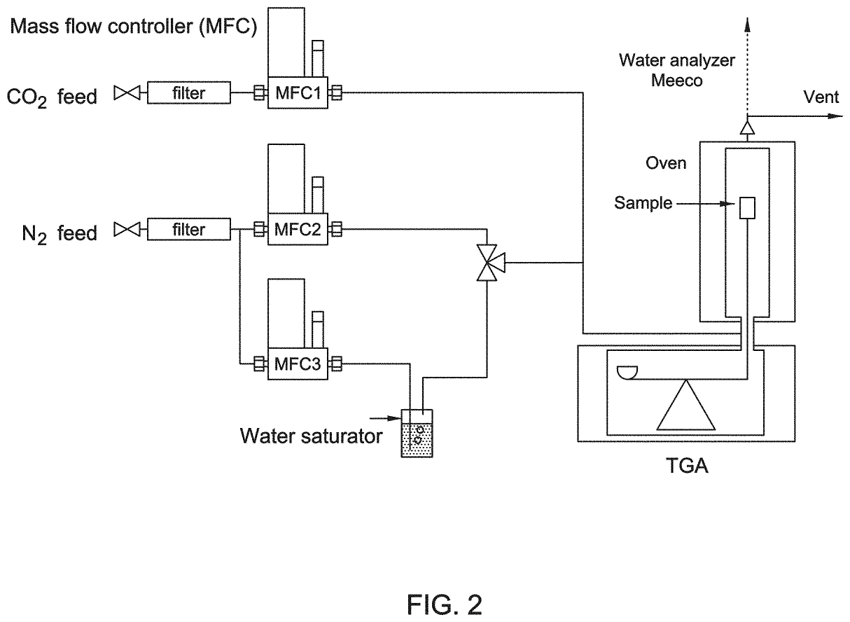

Unless otherwise specified, accelerated hydrothermal stability evaluations described below are made by utilizing a TGA instrument (see FIG. 2) using the following procedure:
1. Place a zeolite sample in the pan of the TGA oven whose temperature is controlled as described below.
2. Using a mass flow controller (MFC), control the flow rate of a feed comprising water, N₂, acidic gas such as CO₂, or combination of the same.
3. The feed passes through the sample in the oven.
4. The sample is continuously exposed to various temperature cycles.
5. Using a microbalance, continuously measure the sample weight as a function of time.
6. If the feed comprises CO₂ (or water), measure the CO₂ (or water) uptake capacity at 30° C., both before and after cycle treatments. Before making uptake capacity measurements, regenerate the sample at 400° C. for 30 mins.

The TGA oven temperature is controlled in a way to mimic temperature swing cycles of a temperature swing adsorption process—high temperature for regeneration and low temperature for adsorption. Depending on whether the sample is in adsorption or desorption stage, the sample weight changes accordingly.

When the feed stream comprises CO₂, by comparing the initial CO₂ uptake capacity measured at the first temperature swing cycle and the final CO₂ uptake capacity after the nth temperature swing cycle, the CO₂ capacity loss can be calculated, which represents the degradation of adsorbents for the following operating conditions used in the testing: CO₂ concentration, temperature, and water concentration.

The feed gas can be a wet stream obtained by flowing N₂ through water saturator or it can be a wet CO₂ stream obtained by mixing CO₂ with wet N₂ stream. The low-level water concentration (less than about 1000 ppm) can be measured using a MEECO Moisture Analyzer at the outlet feed of the TGA. Higher water concentration is calculated from the saturated water pressure in the bubbler with dilution through mixing with dry gas.

In one embodiment, the CO₂ capacity of the zeolite degrades by less than about 10% after 100 cycles of the hydrothermal stability test described above.

The following examples are given as specific illustrations of the claimed invention. It should be understood, however, that the invention is not limited to the specific details set forth in the examples.

### Example 1

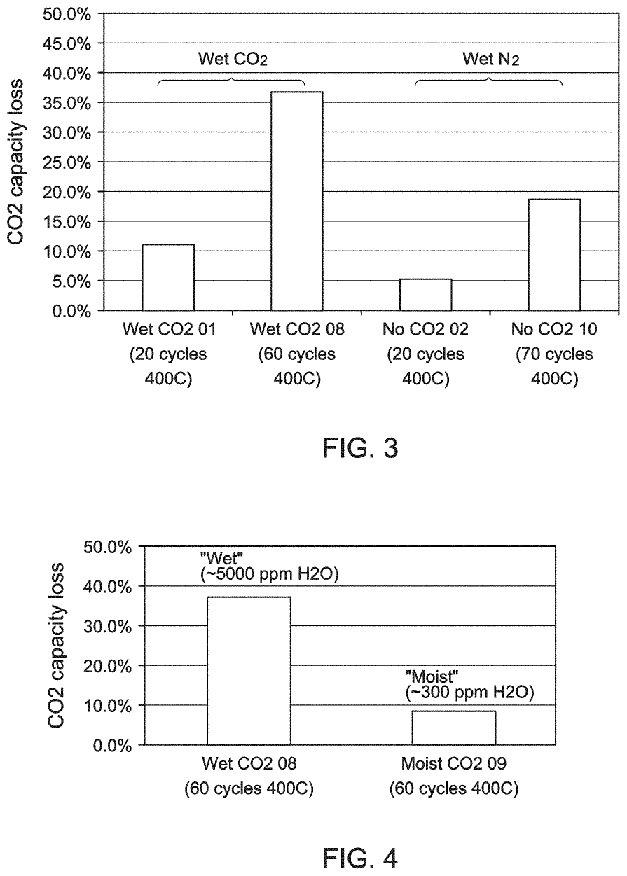

Zeolite 5A crystal¹ was subjected to the accelerated hydrothermal stability test described above². A plot comparing the degradation (resultant CO₂ capacity loss) of zeolite 5A after temperature swing cycles with and without acid streams is shown in FIG. 3. All the tests were accelerated by running high water concentration (about 5000 ppm at 1 bar and water loading of about 13 mol/kg) with or without CO₂ (0.7 bar CO₂ balanced with N₂) and temperature cycles from 35° C. to 400° C. ¹ Zeolite 5A crystals used in the Examples were purchased from Sigma Aldrich (Catalog No.: 233676-5000).² The TGA instrument used in the Examples was TA instruments Q5000 TGA instrument.

The results show that the zeolite 5A crystal underwent more degradation when exposed to acid streams (CO₂ stream in this example) containing water than non-acidic streams containing N₂. It is clear that zeolite 5A degrades more in wet CO₂ streams compared to wet N₂ streams. Specifically, the CO₂ uptake capacity dropped to 11% with wet CO₂ stream compared to 5% with wet N₂ stream after only 20 cycles. With more than 60 cycles, CO₂ uptake capacity dropped to 36% with wet CO₂ stream compared to 16% with wet N₂ only stream.

### Example 2

The following experiment was performed to understand the stability of zeolite 5A in acidic CO₂ streams with lower water content.

The first testing was conducted at 60 temperature swing cycles from 35° C. to 400° C. The CO₂ concentration was kept around 0.7 bar. The two water content levels were: about 5000 ppm and about 300 ppm at 1 bar. MEECO Moisture Analyzer was used to measure the water concentration at the outlet feed passing through the sample. A plot comparing the degradation (resultant CO₂ capacity loss) of zeolite 5A with different water levels after temperature swing from 35° C. to 400° C. is shown in FIG. 4. The results show that zeolite 5A has a minor degradation (8%) for moist feed with about 300 ppm water at 1 bar compared to that for wet feed (36%) with about 5000 ppm at 1 bar (water loading is about 10 mol/kg for this feed).

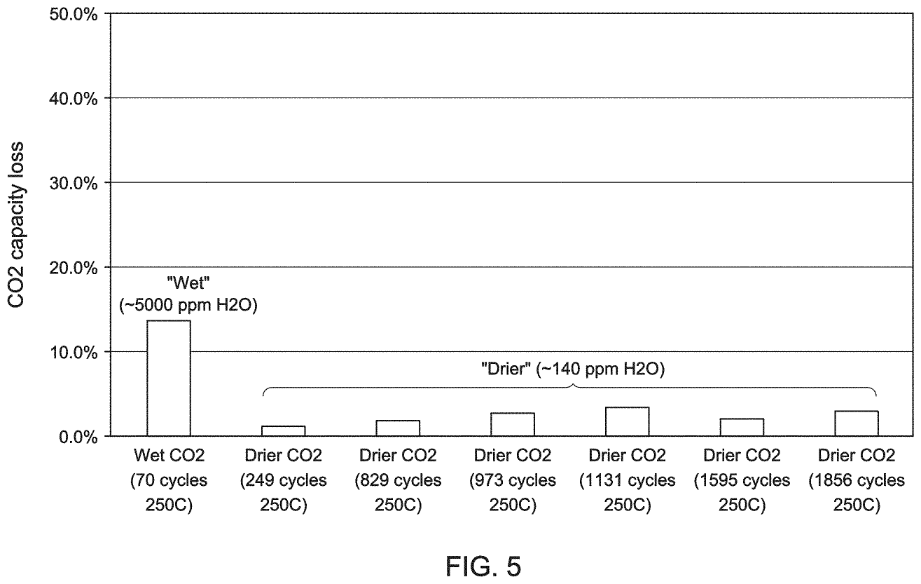

The second testing was carried out at more gentle experimental conditions: temperature swings from 35° C. to 250° C. A lower water concentration (about 140 ppm) was compared to the saturated water level (about 5000 ppm at 1 bar). A plot comparing the degradation (resultant CO₂ capacity loss) of zeolite 5A with different water levels after temperature swing from 35° C. to 250° C. is shown in FIG. 5. The results show that for the CO₂ stream with much lower water concentration (about 140 ppm) used in this testing, zeolite 5A shows minimum degradation, that is, less than 5% for about 2000 cycles.

### Example 3

Silylated zeolite 5A crystals were obtained using the procedure described below:
1. Commercial zeolite 5A was pre-dried in a vacuum oven at 180° C. for 6 hours, and then cooled to room temperature.
2. 2 grams of dried zeolite 5A was added to 10 ml of pure hexamethyldisilazane (HMDS) solution. The solution was constantly stirred for about 1 hour.
3. The resulting solid products were collected by centrifuge and dried at 120° C. in a vacuum oven for 1 hour to get the final silylated zeolite 5A.

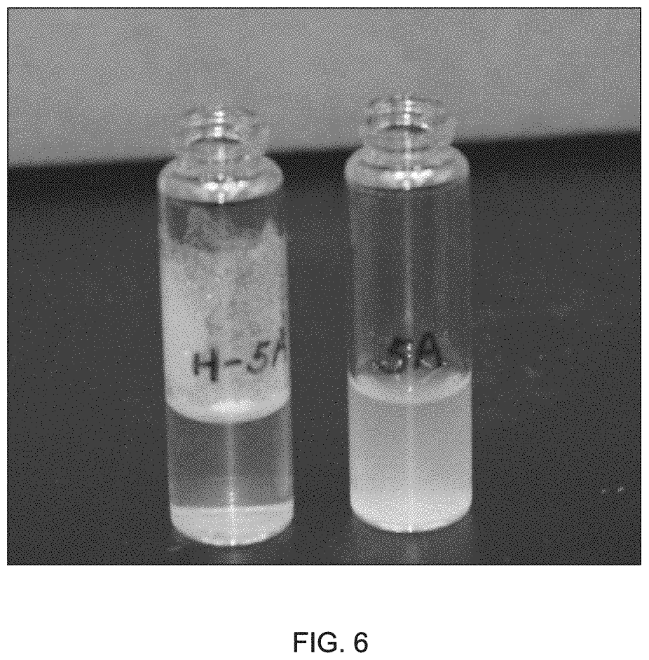

The resulting silylated zeolite 5A appears to be more hydrophobic than the original zeolite 5A crystals. For example, as seen in FIG. 6, the silylated zeolite (“H-5A”) were floating on the water, while the original zeolite 5A (untreated) were well dispersed in water (“5A”). Without being bound by theory, it is hypothesized that after silylation of zeolite 5A, surface —OH groups were minimized, which resulted in a zeolite with more hydrophobic characteristics, such as floatation in water.

### Example 4

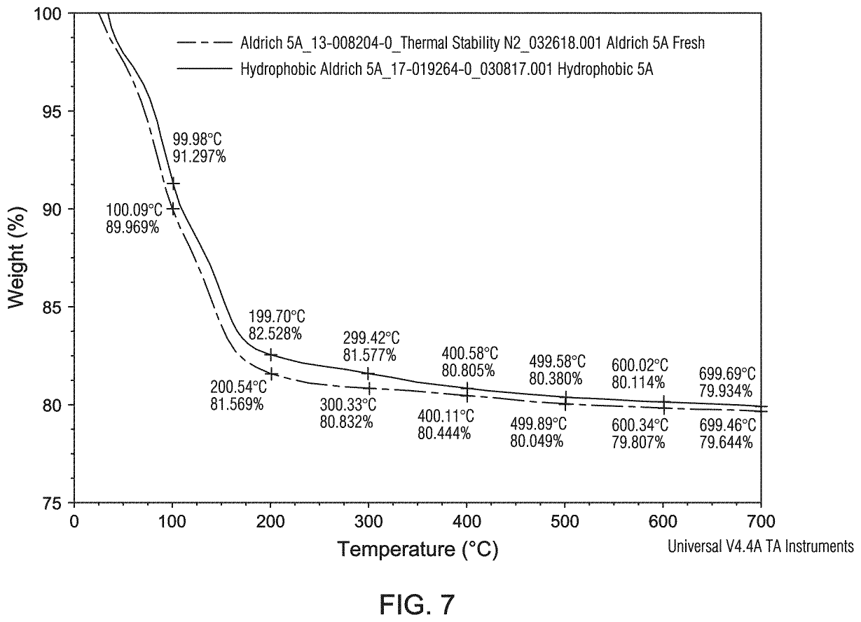

The TGA results for zeolite samples with similar weight loss profile at temperatures up to 700° C. were compared before and after silylation. FIG. 7 compares the TGA results for zeolite 5A silylated with HDMS with that of the original, fresh zeolite 5A that has not undergone silylation. As the weight loss is similar, the silylation agent HDMS does not appear to decompose by heating. Additionally, without being bound by theory, it is hypothesized that the slightly higher weight loss of the original, fresh zeolite 5A that has not undergone silylation compared to that of the silylated zeolite 5A indicates that the original, fresh zeolite 5A appears to have the capability to adsorb slightly more water on its surface than the silylated zeolite 5A, whose surface appears to be slightly more hydrophobic.

### Example 5

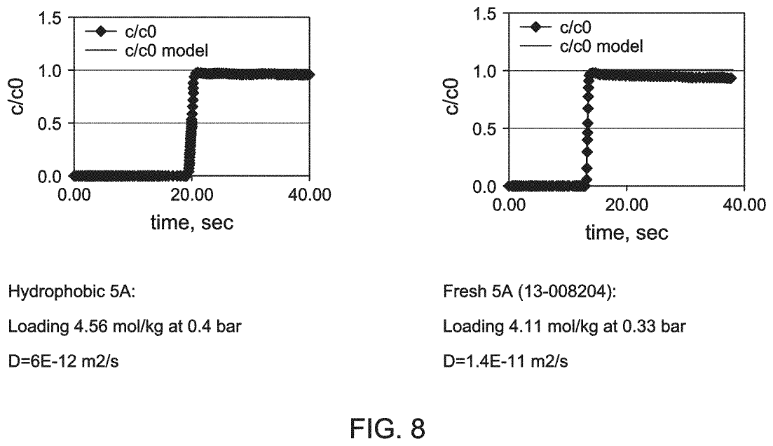

The CO₂ equilibrium and kinetics were evaluated for both silylated zeolite 5A and the original, fresh zeolite 5A that has not undergone silylation. To establish the intrinsic kinetics of zeolite 5A using ballistic chromatography, small (e.g., 3 mg to 10 mg) packed adsorbent bed of zeolite crystals were used to measure breakthrough in a short residence time. Because there was a sharp breakthrough front in FIG. 8 with good swing adsorption capacity, the time to equilibrate CO₂ with the zeolite 5A sample was less than about one-third of the residence time or less than 10 milliseconds. The zeolite adsorption front breakthrough time was measured from the time at which the blank broke through. To calculate the fraction of the capacity at breakthrough, the concentration after breakthrough was adjusted by the response of the blank. The breakthrough was run with CO₂ at 40° C. The diffusivity can be extracted from the breakthrough curves shown in FIG. 8. The results show that both silylated zeolite 5A and fresh zeolite 5A that has not undergone silylation have similar diffusivity. Thus, it was observed that the silylation process does not block CO₂ adsorption, and hence, does not slow down the rapid cycle operation. This was a surprising result as a person of ordinary skill in the art would have expected a silylation agent to alter adsorption kinetics. See, e.g., U.S. Pat. No. 9,095,809.

### Example 6

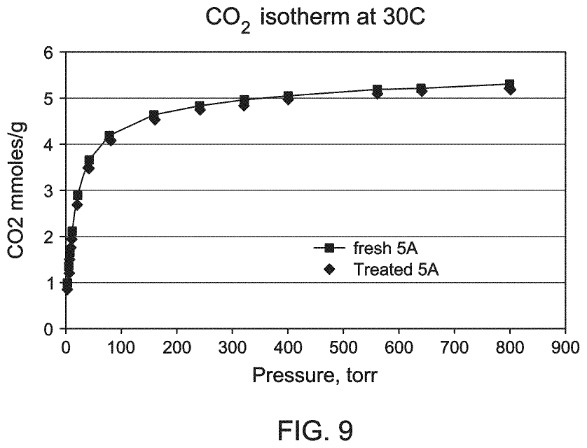

The CO₂ isotherm was measured at 30° C. using a commercial volumetric apparatus (Quantochrom isorb). As seen in FIG. 9, the CO₂ capacity was the same for the silylated zeolite 5A as that of the original, fresh zeolite 5A that has not undergone silylation. This shows that there was no CO₂ capacity loss as a result of the silylation.

### Example 7

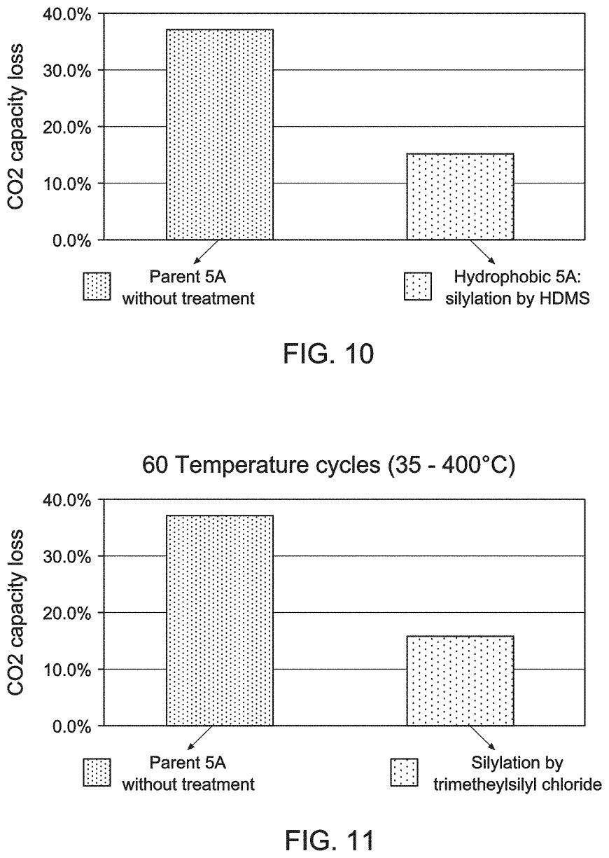

The hydrothermal stability of silylated zeolite 5A and the original, fresh zeolite 5A that has not undergone silylation was evaluated using the accelerated hydrothermal stability test described above. The test was performed for 60 cycles with temperature swing from 35° C. to 400° C. at high water concentration (about 5000 ppm) and 0.7 bar CO₂. The feed contained about 5000 ppm water and 74% CO₂ balanced with N₂ at 1 bar. As seen in in FIG. 10, the CO₂ capacity loss dropped by half for the silylated zeolite 5A, i.e., to about 15% degradation with silylation as compared to about 36% degradation without silylation. Thus, the hydrothermal stability of silylated zeolite 5A shows great improvement compared to that of the original, fresh zeolite 5A that has not undergone silylation.

### Example 8

The hydrothermal stability of zeolite 5A silylated using a different silylation agent (trimethylsilyl chloride) was studied.

Silylated zeolite 5A crystals were obtained using the procedure described below:
1. Commercial zeolite 5A was pre-dried in a vacuum oven at 180° C. for 6 hours, and then cooled to room temperature.
2. 2 grams of dried zeolite 5A was added to 10 ml of pure trimethylsilyl chloride solution. The solution was constantly stirred for about 1 hour.
3. The resulting solid products were collected by centrifuge and dried at 120° C. in a vacuum oven for 1 hour to get the final silylated zeolite 5A.

The hydrothermal stability of silylated zeolite 5A and the original, fresh zeolite 5A that has not undergone silylation was evaluated using the accelerated hydrothermal stability test described above. The test was performed for 60 temperature cycles from 35° C. to 400° C. The feed contained about 5000 ppm water and 74% CO₂ balanced with N₂ at 1 bar. Again, as seen in FIG. 11, the hydrothermal stability of the silylated zeolite 5A was improved as compared to that of the original, the fresh zeolite 5A that has not undergone silylation, with the reduction in degradation being about 50%.

### Example 9

Water uptake capacity was evaluated for both silylated zeolite 5A and the original, fresh zeolite 5A that has not undergone silylation. The accelerated hydrothermal stability test described above was performed, but without the CO₂ stream; N₂ stream was used in the place of the CO₂ stream. The zeolite 5A sample was first regenerated at 400° C., then water uptake capacity was measured before and after exposing wet N₂ stream through a water bubbler. The sample temperature was controlled at 35° C. The water uptake capacity was measured at a water partial pressure of 3 torr and a temperature of 35° C.

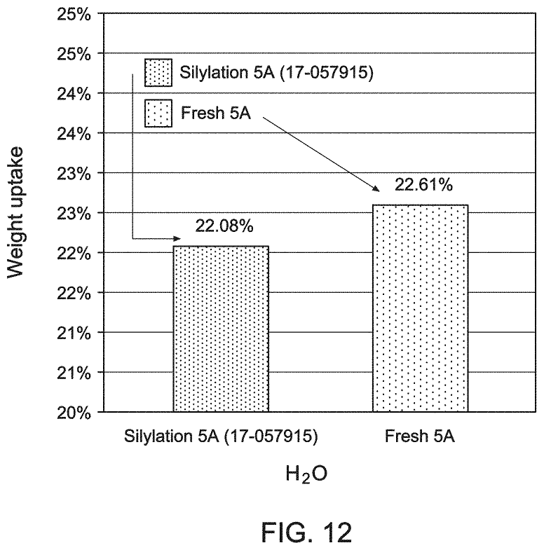

As seen in FIG. 12, the silylated zeolite 5A shows slightly less water capacity (<5%) compared to that of the original, fresh zeolite 5A that has not undergone silylation. This shows the silylated zeolite 5A continues to maintain water uptake capacity, and does not change its hydrophilic property.

Without being bound by theory, it is hypothesized that even though the outside surface of the silylated zeolite 5A exhibits hydrophobicity in water, the inside of the silylated zeolite 5A crystals remain intact, unaffected by the silylation process. The inside micropore surface area is considered to contribute to the adsorption capacity. Since the silylation process greatly reduces degradation, this suggests that the present inventive process creates hydrophobicity only at the external surface of the silylated zeolite, and most degradation happens at the external surface of the small pore zeolite. Thus, it was surprisingly found that the silylation process of the present invention significantly decreases the degradation of the adsorbent comprising the zeolite (as evaluated by adsorptive capacity), while at the same time this process does not significantly change the water capacity in silylated zeolite 5A.

### Example 10

The increase in hydrothermal stability with silylation treatment under wet water temperature swing cycling condition was compared to wet acid gas temperature swing cycling condition. The following process was used to make the comparison:
1. N₂ stream was flowed at 25.00 mL/min through a sample, which was held at 400° C. for 10 mins, and cooled down to 35° C.
2. The N₂ stream was switched through water bubbler and the resultant wet N₂ stream was allowed to pass through the sample for 10 minutes.
3. Cycles were repeated.

The adsorbent hydrothermal stability was evaluated by CO₂ uptake capacity measurement at 35° C. before and after 60 cycles and 120 cycles. The results are shown in Table 1 below:

TABLE 1

| SILYLATED | CYCLE | | DRY CO₂ | |
|---|---|---|---|---|
| ZEOLITE 5A | NUMBER | | UPTAKE | CO₂ LOSS |
| | 0 | cycles | 20.64% | — |
| | 60 | Cycles | 19.96% | 3.3% |
| | 120 | Cycles | 19.63% | 4.9% |
| ORIGINAL, FRESH | CYCLE | | DRY CO₂ | CO₂ LOSS |
| ZEOLITE 5A | NUMBER | | UPTAKE | |
| | 0 | cycles | 21.81% | — |
| | 60 | Cycles | 20.48% | 6.1% |
| | 120 | Cycles | 20% | 8.3% |

Using CO₂ uptake capacity to evaluate material quality, after 60 cycles, the zeolite CO₂ capacity loss was about 6.1% for the original, fresh zeolite 5A compared to 3.3% for that of silylated zeolite 5A. This corresponds to an improvement of about 1.8. This suggests adsorbent lifetime can be extended by about 1.8 times for similar process condition with silylation of the small pore cationic zeolite.

After 120 cycles, the zeolite CO₂ capacity loss is about 8.3% for the original, fresh zeolite 5A compared to about 4.9% of that of silylated zeolite 5A, which corresponds to an improvement of about 1.8. This suggests adsorbent lifetime can be extended by about 1.7 times for similar process condition with silylation of the zeolite.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A process of increasing hydrothermal stability of an adsorbent comprising a zeolite in a swing adsorption process, the process comprising the steps of:
coating the zeolite with a silylation agent to result in a silylated zeolite; and
performing the swing adsorption process,
wherein the swing adsorption process comprises contacting the silylated zeolite with feed stream comprising water, and
wherein the zeolite is a small pore cationic zeolite.

2. The process of claim 1, wherein the small pore zeolite has an 8 membered ring structure.

3. The process of claim 1, wherein the small pore zeolite has a maximum effective pore size of less than about 5 Å.

4. The process of claim 1, wherein the small pore zeolite comprises a structure type ABW, AEI, AFX, ANA, ATT, BCT, BIK, BRE, CAS, CDO, CHA, DDR, EAB, EDI, EEI, EPI, ERI, ESV, GIS, GOO, IHW, ITE, JBW, KFI, LEV, LTA, LTJ, LTN, MER, MON, MTF, MWF, NSI, PAU, PHI, RHO, RTH, SAS, SFW, THO, TSC, UFI, YUG, ETL, IFY, ITW, RTE, RWR, or combinations thereof.

5. The process of claim 2, wherein the small pore zeolite comprises a structure type ABW, AEI, AFX, ANA, ATT, BCT, BIK, BRE, CAS, CDO, CHA, DDR, EAB, EDI, EEI, EPI, ERI, ESV, GIS, GOO, IHW, ITE, JBW, KFI, LEV, LTA, LTJ, LTN, MER, MON, MTF, MWF, NSI, PAU, PHI, RHO, RTH, SAS, SFW, THO, TSC, UFI, YUG, ETL, IFY, ITW, RTE, RWR, or combinations thereof.

6. The process of claim 1, wherein the zeolite is coated before formulating the adsorbent.

7. The process of claim 1, wherein the zeolite is coated after formulating the adsorbent.

8. The process of claim 1, wherein the swing adsorption process is pressure swing adsorption (PSA) process, temperature swing adsorption (TSA) process, pressure temperature swing adsorption (PTSA) process, vacuum swing adsorption (VSA) process, vacuum temperature swing adsorption (VTSA) process, partial pressure purge displacement (PPSA) process, partial pressure temperature swing adsorption (PPTSA) process, displacement desorption swing adsorption (DDSA) process, or combination thereof.

9. The process of claim 1 wherein the swing adsorption process is a rapid cycle swing adsorption process.

10. The process of claim 1, wherein the swing adsorption process removes water from the feed stream and results in a product stream with less than about 10 ppm of water.

11. The process of claim 1, wherein the feed stream further comprises an acid gas, wherein the acid gas is H₂S or CO₂.

12. The process of claim 1, wherein the silylation agent has the general formula:
SiR¹R²R³R⁴,
wherein
at least one of the radicals R¹, R², R³, or R⁴ contains a hydrolysable group, and
the remaining radicals R¹, R², R³, or R⁴ are, independently of one another, an alkyl, alkenyl, alkynyl, heteroalkyl, cycloalkyl, heteroaryl, alkylcycloalkyl, hetero(alkylcycloalkyl), heterocycloalkyl, aryl, arylalkyl or hetero(arylalkyl) radical.

13. The process of claim 12, wherein the silylation agent is hexamethyldisilazane or trimethylsilyl chloride.

14. A process of increasing hydrothermal stability of an adsorbent comprising a zeolite in a swing adsorption process for removal of CO₂ from a feed stream, the process comprising the steps of:
coating the zeolite with a silylation agent to result in a silylated zeolite; and
performing the swing adsorption process for removal of CO₂ from the feed stream,
wherein the swing adsorption process comprises contacting the silylated zeolite with the feed stream, and
wherein the zeolite is a small pore cationic zeolite, and the feed stream comprises CO₂ and water.

15. The process of claim 14, wherein the small pore zeolite has an 8 membered ring structure.

16. The process of claim 14, wherein the small pore zeolite has a maximum effective pore size of less than about 5 Å.

17. The process of claim 15, wherein the small pore zeolite comprises a structure type ABW, AEI, AFX, ANA, ATT, BCT, BIK, BRE, CAS, CDO, CHA, DDR, EAB, EDI, EEI, EPI, ERI, ESV, GIS, GOO, IHW, ITE, JBW, KFI, LEV, LTA, LTJ, LTN, MER, MON, MTF, MWF, NSI, PAU, PHI, RHO, RTH, SAS, SFW, THO, TSC, UFI, YUG, ETL, IFY, ITW, RTE, RWR, or combinations thereof.

18. The process of claim 14, wherein the zeolite is coated before formulating the adsorbent.

19. The process of claim 14, wherein the zeolite is coated after formulating the adsorbent.

20. The process of claim 14, wherein the swing adsorption process is pressure swing adsorption (PSA) process, temperature swing adsorption (TSA) process, pressure temperature swing adsorption (PTSA) process, vacuum swing adsorption (VSA) process, vacuum temperature swing adsorption (VTSA) process, partial pressure purge displacement (PPSA) process, partial pressure temperature swing adsorption (PPTSA) process, displacement desorption swing adsorption (DDSA) process, or combination thereof.

21. The process of claim 14, wherein the swing adsorption process is a rapid cycle swing adsorption process.

22. The process of claim 14, wherein the feed stream comprises less than about 1000 ppm water.

23. The process of claim 14, wherein the adsorption process results in a product stream with less than about 100 ppm of CO₂.

24. The process of claim 14, wherein the silylation agent has the general formula:
SiR¹R²R³R⁴,
wherein
at least one of the radicals R¹, R², R³, or R⁴ contains a hydrolysable group, and
the remaining radicals R¹, R², R³, or R⁴ are, independently of one another, an alkyl, alkenyl, alkynyl, heteroalkyl, cycloalkyl, heteroaryl, alkylcycloalkyl, hetero(alkylcycloalkyl), heterocycloalkyl, aryl, arylalkyl or hetero(arylalkyl) radical.

25. The process of claim 24, wherein the silylation agent is hexamethyldisilazane or trimethylsilyl chloride.
